(19) United States
(12) Patent Application Publication
(10) Pub. No.: US 2009/0289597 A1
(43) Pub. Date: Nov. 26, 2009

(54) CHARGING HOLDER FOR PORTABLE ELECTRONIC DEVICE

(75) Inventor: MING-CHUN WEI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/176,418

(22) Filed: Jul. 21, 2008

(30) Foreign Application Priority Data
May 23, 2008 (CN) 200810301728.2

(51) Int. Cl. H02J 7/00

(52) U.S. Cl. 320/115

(57) ABSTRACT

An exemplary charging holder for a portable electronic device, includes a main body and a base housing. The main body defines a holding groove therein and includes a bottom portion formed in the holding groove. The base housing is connected to the bottom portion of the main body. The base housing includes a circuit board, two charging contacts, and two resilient charging contacts positioned therein. The charging contacts are electrically connected to the circuit board. The resilient charging contacts are positioned adjacent to the circuit board. Each of the resilient charging contacts includes an end portion extending out of the bottom portion of the main body. The resilient charging contacts are separated from the charging contacts and are capable of contacting with the charging contacts when the end portions of the resilient charging contacts are pressed.

### BACKGROUND

1. Field of the Invention

The present invention generally relates to charging holders, particularly, to a charging holder for a portable electronic device.

2. Discussion of the Related Art

Most portable electronic devices adopt rechargeable batteries for supplying power. A typical portable electronic device generally includes a charging connector having charging contacts formed at one end of a housing of the portable electronic device. The charge connector is electrically connected to electrodes of a rechargeable battery in the portable electronic device. When the portable electronic device is inserted into a charging holder, the rechargeable battery can be charged.

Referring to FIGS. 5 and 6, a typical charging holder 10 for the portable electronic device is shown. The charging holder 10 includes a main body 11 and a base housing 12 connected to the main body 11. The main body 11 includes a bottom portion 111 positioned on the base housing 12 and two side portions 112 perpendicularly extending from opposite edges of the bottom portion 111. The bottom portion 111 defines two through holes 1110 in a middle portion of the bottom portion 111. The bottom portion 111 and the side portion 112 cooperatively define a holding groove 13 for holding the portable electronic device. The base housing 12 defines a mounting groove 120, and includes a circuit board 121 and two charging contacts 122 positioned in the mounting groove 120. One end of each charging contact 122 is electrically connected to the circuit board 121 and another end of each charging contact 122 extends out of the bottom portion 111 from one of the through holes 1110 respectively. When the rechargeable battery of the portable electronic device needs to be charged, the portable electronic device is inserted into the holding groove 13 of the charging holder 10 so that the charging contacts of the portable electronic device contact the charging contacts 122 of the charging holder 10 correspondingly.

However, the portable electronic device generally accumulates a great deal of static charge. When the portable electronic device is being inserted into the holding groove 13 of the charging holder 10, at the instant of the charging contacts of the portable electronic device contacting with the charging contacts 122 of the charging holder 10, the static charge is discharged from the portable electronic device via the charging contacts 122 on the circuit board 121. If the voltage created by the static charge is relatively high, the circuit board 121 of the charging holder 10 would damage the charging holder 10.

Therefore, a new charging holder for portable electronic device is desired in order to overcome the above-described shortcomings.

### SUMMARY

An exemplary charging holder for a portable electronic device, includes a main body and a base housing. The main body defines a holding groove therein and includes a bottom portion formed in the holding groove. The base housing is connected to the bottom portion of the main body. The base housing includes a circuit board, two charging contacts, and two resilient charging contacts positioned therein. The charging contacts are electrically connected to the circuit board. The resilient charging contacts are positioned adjacent to the circuit board. Each of the resilient charging contacts includes an end portion extending out of the bottom portion of the main body. The resilient charging contacts are separated from the charging contacts and are capable of contacting with the charging contacts when the end portions of the resilient charging contacts are pressed.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead placed upon clearly illustrating the principles of the present charging holder for portable electronic device. Moreover, in the drawings, like reference numerals designate corresponding parts throughout the several views.

FIG. 1 is a cross-sectional view of a charging holder for portable electronic device in accordance with a first preferred embodiment of the present invention, and showing the charging holder in a non-charging state.

FIG. 2 is similar to FIG. 1, but showing the charging holder in a charging state.

FIG. 3 is a cross-sectional view of a charging holder for portable electronic device in accordance with a second preferred embodiment of the present invention, and showing the charging holder in a non-charging state.

FIG. 4 is similar to FIG. 3, but showing the charging holder in a charging state.

FIG. 5 is an isometric view of a conventional charging holder for portable electronic device, and showing a portable electronic device.

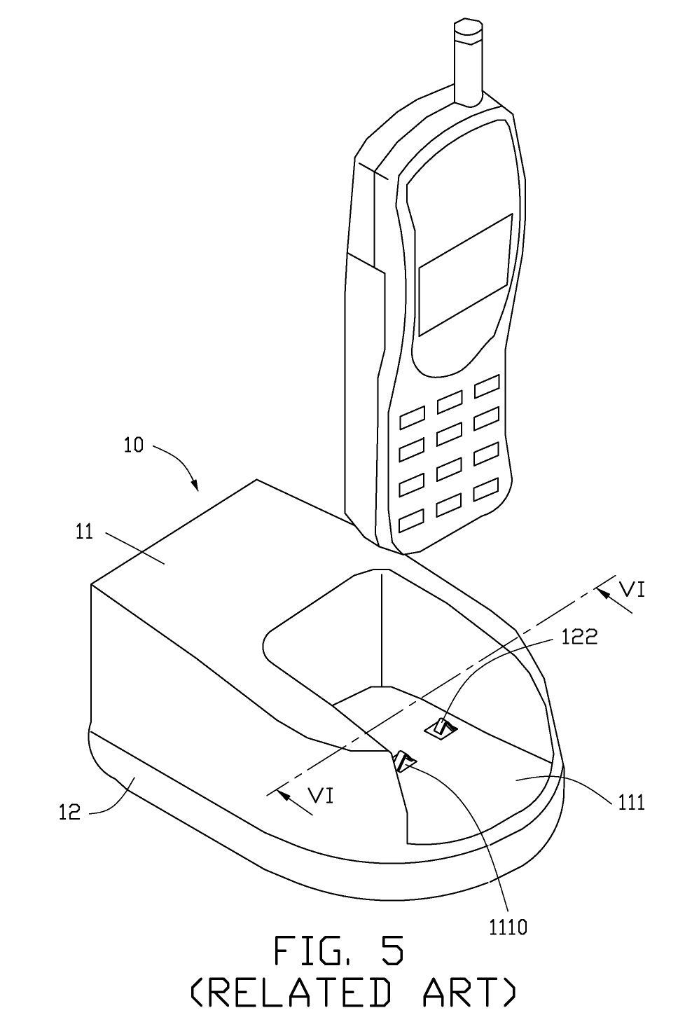

FIG. 6 is a cross-sectional view of the charging holder of FIG. 5, taken along the line VI-VI.

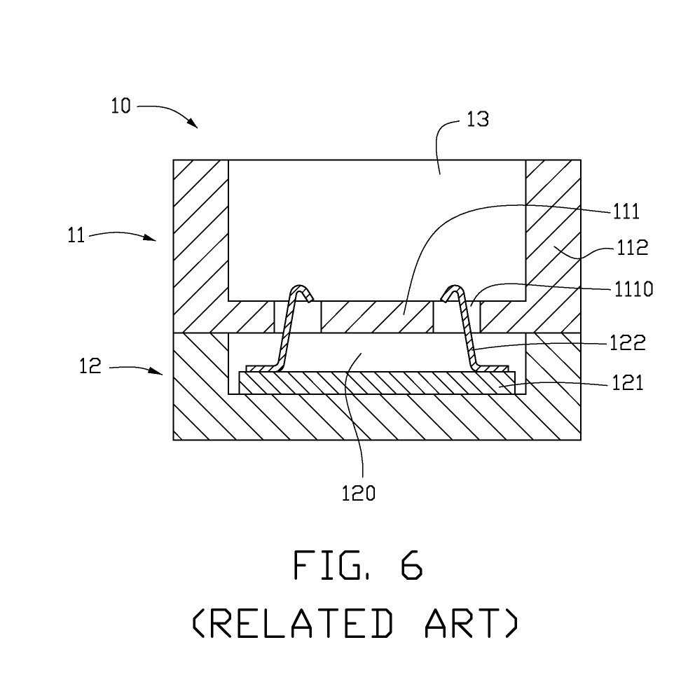

### DETAILED DESCRIPTION OF THE EMBODIMENTS

Reference will now be made to the drawings to describe preferred embodiments of the present charging holder for portable electronic device, in detail.

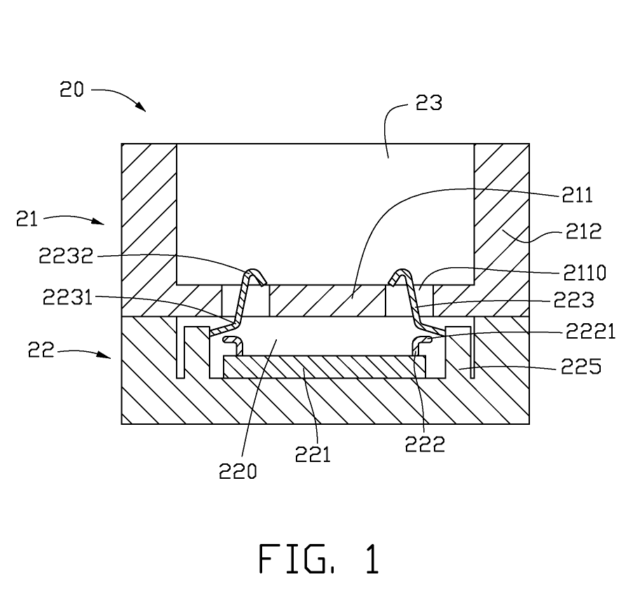

Referring to the drawings in detail, FIG. 1 shows a charging holder 20 for portable electronic device in accordance with a first preferred embodiment of the present invention. The charging holder 20 includes a main body 21 and a base housing 22 connected to the main body 21.

The main body 21 includes a bottom portion 211 positioned on the base housing 22 and two side portions 212 perpendicularly extending from opposite edges of the bottom portion 211. The bottom portion 211 defines two through holes 2110 in the middle portion of the bottom portion 211. The bottom portion 211 and the side portion 212 cooperatively define a holding groove 23 configured for holding a portable electronic device.

The base housing 22 defines a mounting groove 220, and further includes a circuit board 221, two charging contacts 222, two deformable, resilient charging contacts 223, and two fixing portion 225. The circuit board 221 is positioned in the mounting groove 220. The fixing portions 223 perpendicularly extend from a bottom surface of the mounting groove 220 of the base housing 22 and are positioned adjacent to opposite sides of the circuit board 221 in the mounting groove 220 correspondingly. An upper end of each charging contact 222 is bended and forms a contact portion 2221, and a lower end of each charging contact 222 is electrically connected to the circuit board 221. Each resilient charging contact 223 includes a first curved portion 2231 and a second curved portion 2232. One end of each resilient charging contact 223 adjacent to the first curved portion 2231 is fixed to one of the fixing portions 223, and the second curved portion 2232 extends out of the bottom portion 211 from one of the through holes 2110 respectively. When the second curved portion 2232 of each resilient charging contact 223 is pressed downwards by an external force, for instance, by inserting a portable electronic device, the first curved portion 2231 is capable of contacting with the contact portion 2221 of the charging contact 122 due to its elastic deformation.

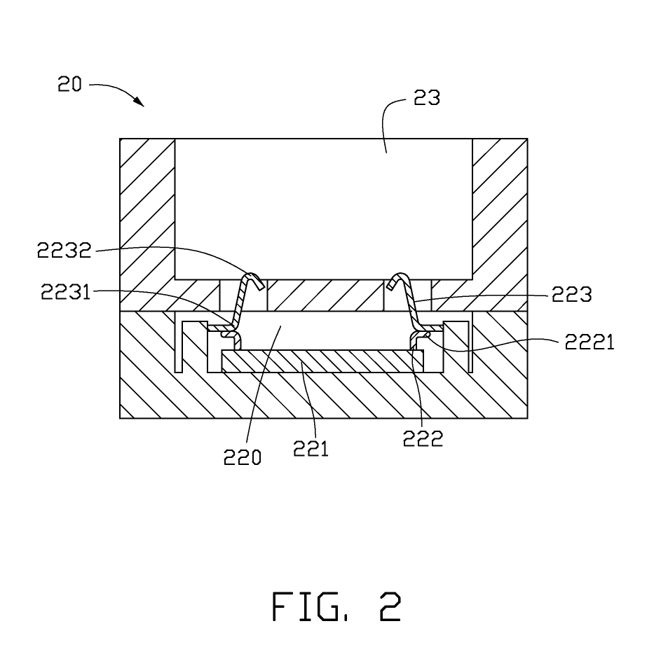

Before a portable electronic device is inserted into the charging holder 20 to charge, the charging holder 20 is in a non-charging state and each resilient charging contact 223 is in a normal position, free of external forces, such that the first curved portion 2231 is separated from the contact portion 2221 of the corresponding charging contact 122. When the portable electronic device is inserted into the holding groove 23 of the charging holder 20, the charging contacts of the portable electronic device press the second curved portions 2232 of the resilient charging contacts 223, thus the first curved portions 2231 elastically deforms and as a result comes into contact with the contact portions 2221 of the charging contacts 122 correspondingly. Referring to FIG. 2, when the first curved portions 2231 of the resilient charging contacts 223 contact the contact portions 2221 of the charging contacts 122 correspondingly, the charging holder 20 is in a charging state, that is, the charging holder 20 charges the portable electronic device.

While inserting a portable electronic device into the holding groove 23 of the charging holder 20, at the instant the charging contacts of the portable electronic device contacts the second curved portions 2232 of the resilient charging contacts 223, the static charge is discharged from the portable electronic device via the resilient charging contacts 223. Because the time of discharging the static charge is quite short (about 10 nanoseconds), the static charge would have completely discharge before the first curved portions 2231 of the resilient charging contacts 223 contacts the contact portions 2221 of the charging contacts 122. The static charge is discharged by the resilient charging contacts 223 before the first curved portions 2231 of the resilient charging contacts 223 contact the contact portions 2221 of the charging contacts 122, thereby preventing the circuit board 221 from being damaged by the static charge. Therefore, a usage life of the charging holder 20 is prolonged.

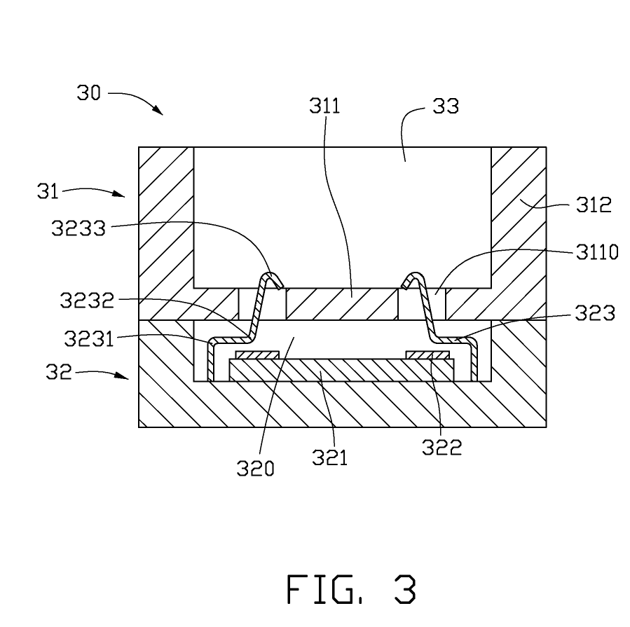

Referring to FIG. 3, a charging holder 30 in accordance with a second preferred embodiment of the present invention is shown. The charging holder 30 is similar in principle to the charging holder 20, and also includes a main body 31 and a base housing 32 connected to the main body 31.

The main body 31 includes a bottom portion 311 positioned on the base housing 32 and two side portions 312 perpendicularly extending from opposite edges of the bottom portion 311. The bottom portion 311 defines two through holes 3110 in the middle portion of the bottom portion 311. The bottom portion 311 and the side portion 312 cooperatively define a holding groove 33.

The base housing 32 defines a mounting groove 320, and includes a circuit board 321, two charging contacts 322, and two deformable, resilient charging contacts 323. The circuit board 321 is positioned in the mounting groove 320. The charging contacts 322 are plane sheet electrically connected to the circuit board 321. The two resilient charging contacts 323 are positioned adjacent to opposite sides of the circuit board 321 respectively. Each resilient charging contact 323 includes a first curved portion 3231, a second curved portion 3232, and a third curved portion 3233. One end of each resilient charging contact 323 adjacent to the first curved portion 3231 is fixed to a bottom surface of the mounting groove 320 of the base housing 32, and the third curved portion 3233 of each resilient charging contact extends out of the bottom portion 311 from one of the through holes 3110 respectively. When the third curved portion 3233 of each resilient charging contact is pressed downwards by an external force, the second curved portion 3232 is capable of contacting with the corresponding charging contact 322.

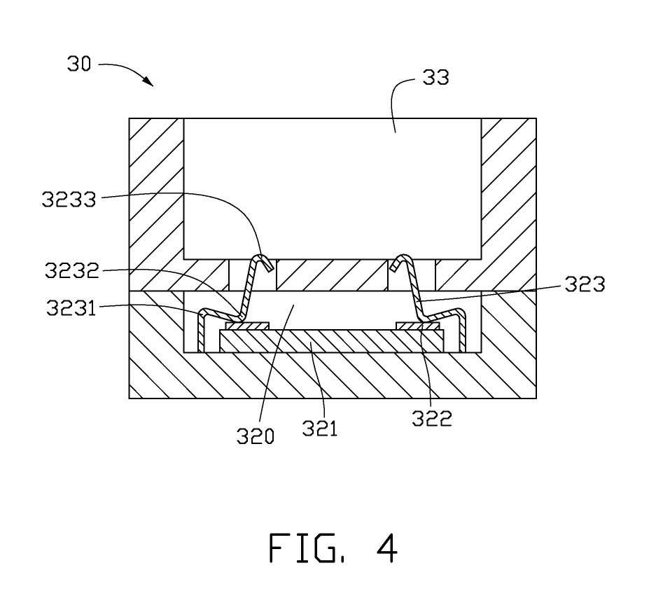

Before a portable electronic device is inserted into the charging holder 30 to charge, the charging holder 30 is in a non-charging state and each resilient charging contact 323 is in a normal position, free of external forces, where the second curved portion 3232 is separated from the contact portion 3221 of the corresponding charging contact 322. When the portable electronic device is inserted into the holding groove 33 of the charging holder 30, the charging contacts of the portable electronic device press the third curved portions 3233 of the resilient charging contacts 323, thus the second curved portions 3232 elastically deforms as a result comes into contact with the contact portions 3221 of the charging contacts 322 correspondingly. Referring to FIG. 4, when the second curved portions 3232 of the resilient charging contacts 323 contact the contact portions 3221 of the charging contacts 322, the charging holder 30 is in a charging state, that is, the charging holder 30 charges the portable electronic device.

It should be pointed out that, the charging contacts 222, 322 and the resilient charging contacts 223, 323 may be other shapes, for example, the charging contacts 222, 322 are replaced by charge pins formed on the circuit boards 221, 321 and the resilient charging contacts 223, 323 are N-shaped pieces. The charging contacts are adjacent to the circuit boards and are separated from the charging contacts before charging and are capable of contacting with the charging contacts when charging.

It should be understood that, the main bodies 21, 31 and the base housings 22, 32 can be separately manufactured so that components such as the circuit boards 221, 321 are conveniently mounted into the base housings 22, 32, and the main bodies 21, 31 can be fixed to the base housings 22, 33 by screws, latching hooks, or adhesive. The main body 21, 31 and the base housing 22, 32 can also be integrally manufactured, but the base housings 22, 32 should define a mounting hole for mounting the components such as the circuit boards 221, 321.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charging holder for a portable electronic device, comprising:
a main body defining a holding groove therein and including a bottom portion formed in the holding groove; and
a base housing connected to the bottom portion of the main body, and the base housing including a circuit board, two charging contacts, and two resilient charging contacts positioned therein, the charging contacts electrically connected to the circuit board, and the resilient charging contacts positioned adjacent to the circuit board;
wherein each of the resilient charging contacts comprises an end portion extending out of the bottom portion of the main body, and the resilient charging contacts are separated from the charging contacts, and capable of contacting with one of the charging contacts when the end portions of the resilient charging contacts are pressed.

2. The charging holder of claim 1, wherein the main body further comprises two side portions extending from opposite edges of the bottom portion, the bottom portion defines two through holes therein, and the bottom portion and the side portion cooperatively form the holding groove.

3. The charging holder of claim 2, wherein a first end of each charging contact is bended and forms a contact portion, and a second end of each charging contact opposite to the first end is electrically connected to the circuit board.

4. The charging holder of claim 3, wherein the base housing defines a mounting groove therein and further comprises two fixing portions, the circuit board is positioned in the mounting groove, the fixing portions are positioned adjacent to opposite sides of the circuit board in the mounting groove, and each resilient charging contact includes a first curved portion corresponding to the contact portion of one of the charging contacts, one end of each resilient charging contact adjacent to the first curved portion is fixed to one of the fixing portions, the end portion of each resilient charging contact is a second curved portion, and the second curved portion of each resilient charging contact extends out of the bottom portion of the main body from one of the through holes in the bottom portion of the main body.

5. The charging holder of claim 4, wherein the first curved portions of the resilient charging contacts are correspondingly separated from the contact portions of the charging contacts, and the first curved portions of the resilient charging contacts are capable of contacting with the contact portions of the charging contacts correspondingly when the second curved portions of the resilient charging contacts being pressed.

6. The charging holder of claim 2, wherein the charging contacts are plane sheet electrically connected to the circuit board.

7. The charging holder of claim 6, wherein each resilient charging contact includes a first curved portion, and a second curved portion, one end of each resilient charging contact adjacent to the first curved portion is fixed in the mounting groove of the base housing, the end portion of each resilient charging contact is a third curved portion at another end, and the third curved portion extends out of the bottom portion from one of the through holes.

8. The charging holder of claim 7, wherein the second curved portions of the resilient charging contacts are capable of contacting with the charging contacts correspondingly when the third curved portions of the resilient charging contacts being pressed.

9. A charging holder, used for a portable electronic device, comprising:
a main body defining a holding groove therein and including a bottom portion formed in the holding groove, the bottom defining two through holes therein; and
a base housing connected to the bottom portion of the main body, and the base housing defining a mounting groove therein and including a circuit board positioned in the mounting groove, two charging contacts electrically connected to the circuit board, and two resilient charging contacts positioned adjacent to opposite sides of the circuit board in the mounting groove;
wherein each of the resilient charging contacts includes a first curved portion and a second curved portion, the second curved portions extend out of the bottom portion of the main body from the through holes correspondingly, and the resilient charging contacts are separated from the charging contacts and the first curved portions of the resilient charging contacts are capable of correspondingly contacting with the charging contacts when the second curved portions of the resilient charging contacts are pressed.

10. The charging holder of claim 9, wherein the main body further comprises two side portions extending from opposite edges of the bottom portion, and the bottom portion and the side portion cooperatively define the holding groove.

11. The charging holder of claim 9, wherein a first end of each charging contact is bended and forms a contact portion corresponding to the first curved portion of each resilient charging contact, and a second end of each charging contact opposite to the first end is electrically connected to the circuit board.
